(19) United States
(12) Patent Application Publication
(10) Pub. No.: US 2007/0186719 A1
(43) Pub. Date: Aug. 16, 2007

(54) Bicycle crank arm, intermediate product and method for manufacturing such a crank arm

(75) Inventors: Gabriele Ciavatta, Roma (IT); Mauri Feltrin, Nanto (Vicenza) (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Campagnolo S.r.l., Vicenza (IT)

(21) Appl. No.: 11/657,279

(22) Filed: Jan. 24, 2007

(30) Foreign Application Priority Data
Feb. 14, 2006 (EP) 06425086.3

(51) Int. Cl. G05G 1/14

(52) U.S. Cl. 74/594.1

(57) ABSTRACT

A bicycle crank arm has an elongated body and a first end portion with a first seat for coupling with a bicycle bottom bracket assembly, a second end portion with a second seat for coupling with a pedal, an intermediate portion extending between the first and second end portions and having an inner portion without structural strength, and a first reinforcement structure and a second reinforcement structure facing the inner portion and the first reinforcement structure and having at least one bundle of structural fibers having at least in part a first orientation. The intermediate portion has a section in which the inner portion occupies a space defined by a first area having a first surface extension and by a second area having a second surface extension and in which the second reinforcement structure occupies a space having a surface extension equal to the difference between the first and second areas.

### FIELD OF INVENTION

The present invention relates to a bicycle crank arm.

The invention also relates to an intermediate product and to a core used for manufacturing such a crank arm. The invention further relates to a method for manufacturing the aforementioned crank arm.

### BACKGROUND

A constant requirement of manufacturers of bicycles and/or of bicycle components, above all of racing bicycles, is to reduce the overall weight of the bicycle and, therefore, of the various components of the bicycle to as low as possible, at the same time ensuring, if not even improving, the characteristics of structural strength of such components.

In order to satisfy this requirement various attempts have been made, e.g., hollow crank arms and/or crank arms made of composite materials have been designed. However, in order to obtain a favorable balance between lightness and structural strength, the structure of the crank arm is often complex and therefore expensive to realize.

### SUMMARY

The applicant has manufactured a bicycle crank arm having an elongated body extending along a longitudinal axis X-X and having:

a first end portion comprising a first seat for coupling with a bicycle bottom bracket assembly;

a second end portion comprising a second seat for coupling with a pedal; and

an intermediate portion having an inner portion without structural strength, a first reinforcement structure and a second reinforcement structure arranged between said inner portion and said first reinforcement structure and comprising at least one bundle of structural fibers having at least in part a first orientation;

wherein said intermediate portion has a section perpendicular to said longitudinal axis X-X in which said inner portion occupies a space defined by a first area having a first surface extension and by a second area having a second surface extension and in which said second reinforcement structure occupies a space having a surface extension equal to the difference between said first and second areas.

### BRIEF DESCRIPTION OF THE DRAWING(S)

Further characteristics and advantages of the crank arm of the present invention shall become clearer from the following description of some preferred embodiments thereof, made hereafter, for indicating and not limiting purposes, with reference to the attached drawings. In such drawings:

FIG. 1 is a perspective view partially in section of a left crank arm according to the present invention;

FIG. 2 is a perspective view of a core for manufacturing the crank arm of FIG. 1;

FIG. 3 is a perspective view that illustrates a preparation step of a preferred embodiment of an intermediate product for manufacturing the crank arm of FIG. 1;

FIG. 4 is a perspective view of a preferred embodiment of an intermediate product for manufacturing the crank arm of FIG. 1;

FIG. 5 is a cross section view along the line V-V of the intermediate product of FIG. 4;

FIG. 6 is a cross section view along the line VI-VI of the crank arm of FIG. 1;

FIGS. 7 and 7a are perspective views of alternative embodiments of the core of FIG. 2;

FIG. 8 is a perspective view of a core for manufacturing a right crank arm according to the invention;

FIG. 8a is a top view of a preferred embodiment of the core of FIG. 8;

FIG. 8b is a view of a detail of the core of FIG. 8a;

FIG. 9 is a perspective view that illustrates a preparation step of a preferred embodiment of an intermediate product for manufacturing a right crank arm according to the invention;

FIG. 10 is a longitudinal section view of a right crank arm manufactured with the core of FIG. 8, the right crank arm having one hollow end;

FIG. 11 is a section view of a mold for manufacturing the crank arm of FIG. 1, having the intermediate product of FIG. 4 in its cavity;

FIG. 12 is a cross section view of an alternative embodiment of the crank arm of FIG. 1, along a plane orthogonal to its longitudinal axis; and

FIG. 13 is a longitudinal section view of the right crank arm of FIG. 10 with both ends hollow.

### DETAILED DESCRIPTION OF THE PREFERRED EMBODIMENT(S)

Introduction

The present invention therefore relates, in a first aspect thereof, to a bicycle crank arm comprising an elongated body extending along a longitudinal axis X-X and having:

a first end portion comprising a first seat for coupling with a bicycle bottom bracket assembly;

a second end portion comprising a second seat for coupling with a pedal;

an intermediate portion extending between the first end portion and the second end portion and comprising an inner portion without structural strength, a first reinforcement structure and a second reinforcement structure arranged between the inner portion and the first reinforcement structure and comprising at least one bundle of structural fibers having at least in part a first orientation;

wherein the intermediate portion has a section perpendicular to the longitudinal axis X-X in which the inner portion occupies a space defined by a first area having a first surface extension and by a second area having a second surface extension and in which the second reinforcement structure occupies a space having a surface extension equal to the difference between the first and second areas.

Advantageously, the crank arm of the present invention achieves a favorable balance between lightness and structural strength. Indeed, the second reinforcement structure is arranged at the areas of the crank arm most stressed in operation, the other areas being hollow or made from material without structural capability. Moreover, in such a crank arm, advantageously, when a stress is transmitted from the first reinforcement structure to the second reinforcement structure through their mutual contact surfaces, the second reinforcement structure is free to deform at the surface thereof which faces the inner portion of the crank arm. Indeed, since the inner portion of the crank arm does not have structural capability, at the interface surface between the second reinforcement structure and the inner portion no constraint tension is generated that, acting in contrast to the deformation stress of the second reinforcement structure, would cause the detachment of the second reinforcement structure from the first reinforcement structure. Advantageously, in the case in which the inner portion is defined by a cavity, the constraint tensions are completely zero.

Preferably, the second reinforcement structure is arranged in the perpendicular section so that each surface portion of the second reinforcement structure that faces the first reinforcement structure is opposite a respective surface portion of the second reinforcement structure that faces the inner portion.

Preferably, the fibers of the second reinforcement structure are unidirectional continuous structural fibers extending, at the intermediate portion, substantially parallel to the longitudinal axis X-X. Such fibers, advantageously, give the crank arm a structural resistance to traction stresses.

Preferably, the fibers of the first reinforcement structure are unidirectional continuous structural fibers extending substantially along at least one direction inclined with respect to the longitudinal axis X-X by a first predetermined angle. More preferably, the first predetermined angle is equal to about 45°. The applicant has indeed found that this inclination is optimal for giving the crank arm characteristics of resistance to traction, bending, and torsion stresses.

The fibers of the first reinforcement structure can, however, be pieces of fibers or small sheets of fabric having a random arrangement.

Preferably, the aforementioned structural fibers are incorporated in a composite material, preferably polymeric.

Preferably, the first and the second end portion of the crank arm comprise a composite material comprising structural fibers arranged randomly and incorporated in a polymeric material. Advantageously, the structural fibers arranged randomly, for example in the form of small sheets of fabric or pieces of fibers, are capable of flowing when subjected to pressure in a mold and therefore are able to optimally fill the end areas of the cavity of the mold so as to form the end portions of the crank arm. Such end portions, being in any case made from a material comprising structural fibers, have the desired characteristics of structural strength.

Preferably, the structural fibers in the composite material, whether continuous or in pieces arranged randomly, are selected from the group consisting of: carbon fibers, glass fibers, aramid fibers, boron fibers, ceramic fibers, and combinations thereof, carbon fibers being most preferred.

Preferably, the polymeric material in the composite material is a thermosetting material. More preferably, the thermosetting material comprises an epoxy resin. However, the possibility of using a thermoplastic material is not excluded.

Preferably, the elongated body of the crank arm has a first face adapted to face a bicycle frame and a second face opposite the first face, and the second reinforcement structure of the intermediate portion of the crank arm is closer to the second face than to the first face.

In a first embodiment of the crank arm of the present invention, in particular in the case of a left crank arm, the second reinforcement structure also extends at at least one of the end portions and, at the at least one of the end portions, is closer to the first face than to the second face.

In a second embodiment of the crank arm of the present invention, in particular in the case of a right crank arm, such a crank arm comprises at least one reinforcement structure also at at least one of the end portions and the reinforcement structure, at the at least one of the end portions, is closer to the second face than to the first face.

In both of the embodiments discussed above, advantageously, the second reinforcement structure is arranged at the area of the crank arm most stressed during pedaling. Such an area, in the left crank arm, is the one at the area for coupling with the bottom bracket assembly, on the side facing towards the bicycle frame, whereas in the right crank arm it is the face of the crank arm facing outwards.

In the case of the left crank arm, the reinforcement structure of the end portion of the crank arm can be an extension of the second reinforcement structure of the intermediate portion of the crank arm. Preferably, however, the reinforcement structure of the end portion of the crank arm is distinct from the reinforcement structure of the intermediate portion of the crank arm, as shall be described more clearly hereafter.

Preferably, the intermediate portion of the elongated body has a section perpendicular to the longitudinal axis X-X in which the second reinforcement structure has a height equal to about half the height of the inner portion. In this way a hollow, and therefore light, crank arm is obtained, in which the second reinforcement structure is arranged at the part of the crank arm most stressed in operation.

Preferably, the aforementioned inner portion is defined by a first cavity. In alternative embodiments, the inner portion can be made from material without structural capability, for example, expanded polyurethane.

Preferably, the second reinforcement structure extends longitudinally along the elongated body and winds in a loop around the first and second end portions and the intermediate portion. Advantageously, a reinforcement structure made in this way gives the crank arm a high resistance to traction loads.

More preferably, the elongated body of the crank arm further comprises, at at least one of the end portions, at least one holding element of a portion of the second reinforcement structure. Advantageously, such a holding element, during the molding process of the crank arm, contributes to keep tensioned and in position the fibers of the second reinforcement structure at the end portions of the crank arm. The presence of structural fibers is therefore ensured at the areas of the crank arm most stressed during pedaling, among which there is in particular the end portion of the crank arm for coupling with the bottom bracket assembly of the bicycle. Even more advantageously, the holding element ensures that, during molding, due to the flowing of the filling material, the fibers do not shrivel in the end portions of the crank arm. The applicant has indeed found that the structural fibers, if bent excessively, can break. A possible shriveling would thus generate weakening points in the structure of the body of the crank arm.

Preferably, the holding element has a small thickness at an outer surface portion thereof facing the inner portion of the intermediate portion of the elongated body. Advantageously, this allows the core adapted to form the lightened inner portion of the crank arm to be brought closer towards the end area of the crank arm itself and therefore allows a crank arm to be obtained in which the lightened inner portion has greater longitudinal extension.

For example, the holding element can be defined by a ring nut adapted to be screwed into an outer threading formed on a forming element of the end portion of the crank arm, but any other type of coupling is not excluded.

Preferably, the holding element, given that it is intended to remain within in the finished crank arm, is made from a light material, such as a composite material or a metal alloy. The weight of the crank arm thus remains low.

More preferably, the holding element is made from phenolic resin loaded with glass fiber, the content of the glass fibers preferably being equal to 40-50%. The applicant has found that a holding element thus made gives excellent performance results combined with a particularly low cost.

Preferably, at least one of the first and second end portions comprises, at the seat, a respective coupling hole.

More preferably, the crank arm further comprises, at the coupling hole, a plurality of centering elements of a forming element of the end portion.

Such centering elements are preferably made from the same material as the crank arm and, more preferably, extend cantilevered from the coupling seat inside the coupling hole.

Preferably, the crank arm further comprises a second cavity extending around the coupling hole. The cavity around the coupling hole advantageously produces an even lighter crank arm.

Preferably, an insert adapted to allow the coupling of the crank arm with the bottom bracket assembly of the bicycle or with a pedal is inserted into the coupling hole.

Preferably, the second cavity is an extension of the first cavity formed at the intermediate portion of the crank arm. Nevertheless, the possibility that the cavity formed in the end portion of the crank arm and the cavity formed in the intermediate portion of the crank arm can be distinct and separate is not excluded.

Preferably, the second cavity has a height at least in part shorter than the height of the first cavity, so that the crank arm, at the coupling areas with the bottom bracket assembly and with the pedal, has areas of increased thickness suitable for ensuring the desired structural strength.

Nevertheless, alternative embodiments in which the second cavity has a height equal to that of the first cavity, or to that of the insert inserted into the respective coupling seat formed in the end portion of the crank arm, are not excluded.

In a specific embodiment of the crank arm of the present invention, the first and the second end portion both comprise a respective second cavity extending around the respective coupling seat.

As already stated, the crank arm of the present invention can be a left crank arm or a right crank arm. In the case in which it is a right crank arm, it comprises, at the end portion thereof for coupling with the bottom bracket assembly of the bicycle, a plurality of spokes that, preferably, comprise respective cavities that branch from the second cavity formed around the coupling seat provided in the end portion of the crank arm. A particularly light right crank arm is thus made.

Preferably, the bundle of unidirectional fibers that constitutes the second reinforcement structure of the intermediate portion of the crank arm extends along the spokes around the respective cavities and follows the profile thereof, so as to ensure that the crank arm has structural strength also at the spokes.

Preferably, the height of the cavities of the spokes is greater than that of the cavity around the coupling seat formed in the end portion of the crank arm. A thickened area around the seat for coupling with the bottom bracket assembly is thus obtained in the crank arm; such thickening ensures the desired characteristics of structural strength in this area of the crank arm that is particularly stressed during pedaling. Such an area, in particular, is the area for coupling with the bottom bracket assembly, on the side facing outwards.

Preferably, the crank arm of the present invention comprises a layer of continuous structural fibers wound in a spiral around the coupling seat. This is to enhance the characteristics of resistance to stress of the crank arm at the aforementioned area for coupling with the bottom bracket assembly.

In a second aspect thereof, the invention relates to an intermediate product for manufacturing a bicycle crank arm, such an intermediate product comprising a core having an elongated body extending along a longitudinal axis X-X, a first reinforcement structure and a second reinforcement structure comprising at least one bundle of structural fibers having at least in part a first orientation. The intermediate product further comprises a section perpendicular to the longitudinal axis X-X in which the core occupies a space defined by a first area having a first surface extension and by a second area having a second surface extension and in which the second reinforcement structure occupies a space having a surface extension equal to the difference between the first and second areas.

Advantageously, the intermediate product described above can be used to manufacture the crank arm of the present invention, and thus results in the advantages mentioned above with reference to such a crank arm.

Preferably, the intermediate product of the present invention comprises, individually and/or in combination, all of the preferred structural characteristics described above with reference to the crank arm and correlated to the presence, composition, and arrangement of unidirectional structural fibers incorporated in a composite material, possibly a filling material.

Preferably, the second reinforcement structure is arranged in the perpendicular section in such a way that each surface portion of the second reinforcement structure that faces the first reinforcement structure is opposite a respective surface portion of the second reinforcement structure that faces the core.

Preferably, the fibers of the bundle of fibers of the second reinforcement structure are unidirectional continuous structural fibers extending substantially parallel to the longitudinal axis X-X and the fibers of the first reinforcement structure are unidirectional continuous structural fibers extending substantially along at least one direction that is inclined, preferably by 45°, with respect to the longitudinal axis X-X.

Even more preferably, the aforementioned intermediate product also comprises at least one first layer of filling material capable of flowing under pressure and arranged between the core and the second reinforcement structure. More preferably, at least one second layer of filling material is associated with the first reinforcement structure at the outside thereof. Such a filling material is intended to form the end portions of the crank arm following a pressure molding operation of the intermediate product thus arranged.

Preferably, the elongated body of the core comprises opposite longitudinal sides provided with respective housing seats of respective portions of the fibers of the bundle of fibers.

Preferably, each housing seat is defined by a side surface of the elongated body of the core and by a projecting surface that projects laterally from the side surface. Advantageously, such a projecting surface, when the intermediate product is inserted into the cavity of the mold to manufacture the crank arm, is provided so as to be arranged between the pressure element of the mold and a portion of the second reinforcement structure defined by the aforementioned bundle of fibers so that, when the pressure element is actuated, the projecting surface exerts a uniform pressure on such a portion of second reinforcement structure keeping tensioned the fibers of the structure and thus avoiding the shriveling thereof due to the flow of the filling material.

This is particularly advantageous if the bundle of fibers of the second reinforcement structure also embraces two forming elements of the end portions of the crank arm. The tension generated by the thrusting of the aforementioned projecting surface of the core indeed prevents the flowing of the filling material on two opposite sides of the aforementioned forming elements causing a shriveling of the fibers of the reinforcement structure at the forming elements, such shriveling generating weakening points in the finished crank arm.

Preferably, the core is made from a metallic material having a low melting point to allow it to be removed by melting when the crank arm has been manufactured. The material having a low melting point is in particular a material capable of melting at a temperature slightly higher than the cross-linking temperature of the composite material. In this way the core allows very high pressures to be applied that optimally compact the composite material and the filling material, inducing an intense degasification.

Preferably, in the case in which one wishes to make a crank arm having a cavity around the seats for coupling with the bottom bracket assembly and/or with the pedal, the core comprises a central body portion and two rings integrally associated with the elongated body at opposite ends of the central body portion. The two rings create the cavities in the end portions of the crank arm whereas the central body portion of the core creates the cavity at the intermediate body portion of the crank arm.

Preferably, a ring of the pair of rings has a height at least in part shorter than the height of the central body portion. Such a ring of shorter height is adapted to create the cavity at the end portion for coupling with the bottom bracket assembly of the bicycle. Advantageously, the fact that such a ring has a shorter height than that of the central body portion of the core makes it possible to not exert a pressure on the portion of the bundle of structural fibers supported by the holding element during the molding of the crank arm, thus ensuring correct tensioning of such fibers.

Preferably, at least part of the ring has a height shorter than the height of the projecting surface of the central body portion of the core. The ring can also have at least one body portion having a height greater than that of the remaining body portion.

The other ring of the pair of rings can have a height substantially equal to the height of the projecting surface or equal to that of the other ring.

Preferably, the aforementioned rings comprise respective positioning elements extending towards the inside of the rings. Advantageously, such positioning elements, pressing in the molding step against the forming inserts of the end portions of the crank arm, prevent the core from moving.

In a preferred embodiment thereof, the core comprises, at one of the two rings, a central hole and a plurality of spokes that extend radially outwards from the central hole. Such a core is advantageously used in the manufacture of a right crank arm, where the spokes of the crank arm are used to support the gear wheels of the sprocket assembly of the bicycle.

Preferably, the spokes of the core have a height greater than the height of the ring at the central hole. Advantageously, the crank arm obtained using such a core therefore comprises, around the seat for coupling with the bottom bracket assembly of the bicycle, a thickened area that ensures a high structural strength in an area where there is notoriously a high concentration of tensions.

Preferably, a layer of continuous structural fibers is wound in a spiral around the central hole. More preferably, the aforementioned bundle of structural fibers extends along the spokes, following the profile thereof. The structural strength of the finished crank arm is thus increased at the spokes.

Preferably, in the case in which one wishes to make a right crank arm, the projecting surface defined on the sides of the elongated body of the core extends parallel to the axis X-X for a part having a length shorter than the length of the central body portion of the core. This promotes a thickening of the body of the crank arm at the joining area between the intermediate portion and the end portion for coupling with the bottom bracket assembly of the bicycle, i.e. where there is notoriously a high concentration of tensions.

In a third aspect thereof, the invention relates to a core for manufacturing a hollow bicycle crank arm, such a core comprising an elongated body extending along a longitudinal axis X-X. The elongated body comprises, at opposite longitudinal sides thereof, a side surface and a projecting surface that projects laterally from the side surface.

Advantageously, the core described above can be used to manufacture the crank arm of the present invention, and therefore achieves the advantages mentioned above with reference to such a crank arm.

Preferably, the core of the present invention comprises, individually and/or in combination, all of the preferred structural characteristics described with reference to the core of the intermediate product for manufacturing the crank arm of the present invention described above.

In a fourth aspect thereof, the invention relates to a method for manufacturing a bicycle crank arm, comprising the steps of:

providing a core adapted to define an inner cavity of an intermediate portion of a crank arm, the core comprising an elongated body extending along a longitudinal axis X-X;

providing two forming elements of opposite end portions of the crank arm;

providing an intermediate product comprising the core, a first reinforcement structure and a second reinforcement structure arranged between the core and the first reinforcement structure and comprising at least one bundle of structural fibers having at least in part a first orientation, the intermediate product having a section perpendicular to the longitudinal axis X-X in which the core occupies a space defined by a first area having a first surface extension and by a second area having a second surface extension and in which the second reinforcement structure occupies a space having a surface extension equal to the difference between the first and second areas;

associating the forming elements with the intermediate product, the forming elements being arranged between the core and the second reinforcement structure at opposite free ends of the core;

introducing the intermediate product with the forming elements into a cavity of a mold together with at least one mass of filling material comprising a polymeric material and capable of flowing under pressure, the mold being equipped with a pressure element and the cavity having the shape of the crank arm;

applying a predetermined pressure to the pressure element to make the filling material flow in the cavity;

heating the mold to a temperature corresponding to the cross-linking temperature of the polymeric material; and

opening the mold and removing the formed crank arm.

Through this method it is advantageously possible to manufacture the crank arm of the present invention.

Preferably, the second reinforcement structure is housed in a pair of housing seats formed on opposite longitudinal sides of the core.

More preferably, each housing seat is defined by a side surface of the core and by a projecting surface that projects laterally from the side surface and the intermediate product is inserted in the cavity of the mold so that the pressure element acts upon a first portion of the second reinforcement structure through the projecting surface.

Preferably, the method of the present invention further comprises the step of providing a holding element of a second portion of the second reinforcement structure on at least one of the forming elements so that the holding element acts upon the second reinforcement structure on the opposite side to the projecting surface of the core.

Preferably, the step of providing an intermediate product comprises the step of winding at least one bundle of unidirectional continuous structural fibers in a loop around the two forming elements and the core.

Preferably, the core consists of a metallic material having a low melting point, and the method of the present invention further comprises, after the step of heating the mold, the steps of:

forming at least one hole on a surface of the crank arm;

heating the crank arm up to the melting point of the metallic material having a low melting point in order to allow it to flow out.

In this way, advantageously, a cavity is obtained at the space occupied by the core thus manufacturing a crank arm having the desired characteristics of lightness.

Preferably, the melting point is higher than the cross-linking temperature of the polymeric material by a value ΔT of between about 1° C. and about 25° C. More preferably, the melting point is higher than the cross-linking temperature of the polymeric material by a value ΔT equal to about 5° C.

Preferably, the first reinforcement structure comprises unidirectional continuous structural fibers that extend along a preferential direction of extension and the step of providing the intermediate product comprises the step of arranging the at least one layer of structural fibers so that the preferential direction of extension is inclined with respect to the longitudinal axis X-X by a predetermined angle, preferably equal to about 45°.

Preferably, the method further comprises, before the step of insertion of the intermediate product and of the mass of filling material in the cavity of the mold or after the aforementioned insertion step and before the step of application of the predetermined pressure, the step of preheating the intermediate product and the at least one mass of filling material bringing it to a predetermined preheating temperature for a predetermined preheating time. This preheating step is used to make the composite material of the first reinforcement structure and possibly of the layer of structural fibers that wind in a loop around the core and the aforementioned forming elements more easily malleable during molding and the filling material more easily capable of flowing under pressure.

The parameters of the preheating step are selected so as to achieve homogeneous heating without the polymeric components aging excessively. A first preferred range of values is given by a temperature of between about 60° C. and about 100° C., maintained for a time of between about 5 and about 70 minutes. An even more preferred range of values is given by a temperature of between about 80° C. and about 100° C. maintained for a time of between about 5 and about 60 minutes. A particularly preferred range of values is given by a temperature of between about 85° C. and about 90° C. maintained for a time of between about 35 and about 55 minutes. In this way it is possible to serve a mold with a limited number of preheating ovens.

Preferably, the step of inserting the intermediate product into the cavity of the mold together with the at least one mass of filling material comprises the step of providing at least one first layer of filling material between the core and the first reinforcement structure.

More preferably, at least one second layer of filling material is also inserted outside of the first reinforcement structure.

In this way it is possible to obtain an optimal distribution of the filling material in the cavity of the mold and therefore an end product of high quality both in terms of structure and appearance.

Preferably, the aforementioned filling material is a composite material comprising portions of structural fibers, preferably pieces or small sheets of fibers arranged randomly and incorporated in a polymeric material.

Preferably, the predetermined pressure exerted by the pressure element during the molding of the crank arm is between about 5 bar and 400 bar, more preferably between 40 bar and 300 bar and even more preferably between 200 bar and 300 bar.

The structural fibers, continuous or in pieces, and the polymeric material of the composite material are selected as described above with reference to the crank arm of the present invention.

The present invention also relates, in a further aspect thereof, to a bicycle crank arm, comprising an elongated body extending along a longitudinal axis X-X and having:

a first end portion comprising a first seat for coupling with a bicycle bottom bracket assembly;

a second end portion comprising a second seat for coupling with a pedal; and

an intermediate portion extending between the first end portion and the second end portion;

wherein at least one of the first and second end portions comprises, at the seat, a coupling hole and a cavity extending around the coupling hole.

Preferably, at least one of the first and second end portions is at least in part made with a cross-linkable composite material capable of flowing under pressure before cross-linking.

Advantageously, such a crank arm comprises end portions provided with respective cavities around respective coupling holes; such portions are formed through molding using a cross linkable composite filling material capable of flowing under pressure around the inserts. The filling material is distributed homogeneously in the cavity of the mold without creating points of non-homogeneity that would constitute points of concentration of tension and, therefore, weakening points of the structure.

Preferably, the cavity continuously surrounds the coupling hole.

Preferably, such a crank arm comprises all of the preferred structural characteristics discussed above.

In a further aspect thereof, the invention relates to a core for manufacturing a hollow bicycle crank arm, comprising an elongated body extending along a longitudinal axis X-X. The elongated body comprises a central body portion and two rings integrally associated with the elongated body at opposite ends of the central body portion.

Such a core can be used to manufacture the crank arm described above and preferably has all of the structural characteristics described above.

### DETAILED DESCRIPTION

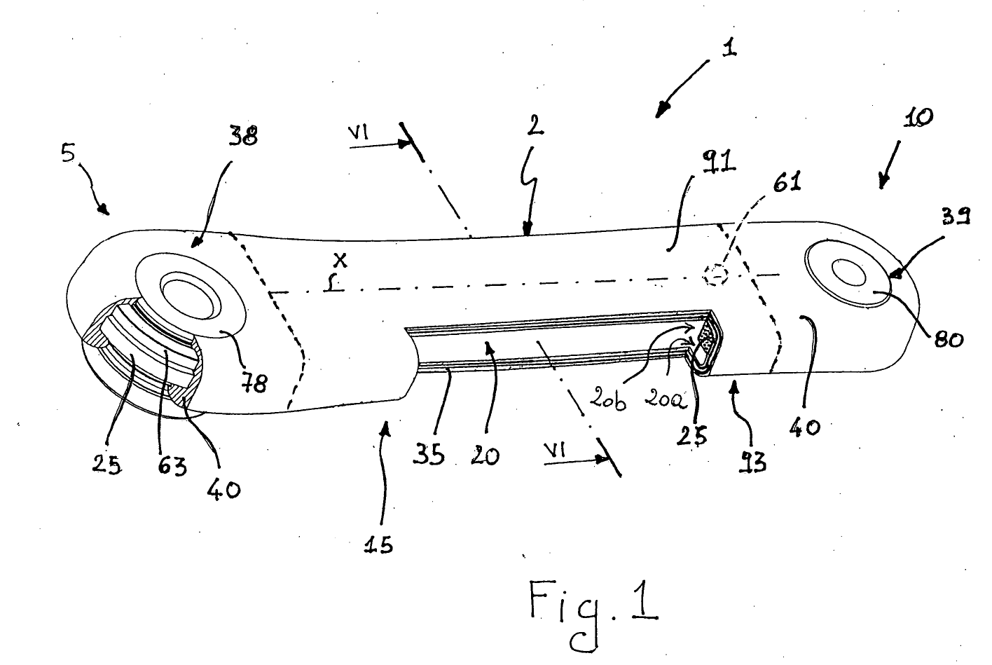

With reference to FIG. 1, a bicycle crank arm, in particular a left crank arm, in accordance with the invention is wholly indicated with 1.

The crank arm 1 comprises an elongated body 2 extending along a longitudinal axis X-X and has a first end portion 5 comprising a first seat 38 for coupling with a bottom bracket assembly (not shown) of the bicycle, a second end portion 10 comprising a second seat 39 for coupling with a pedal (not shown), and an intermediate portion 15 extending between such end portions 5, 10. On the crank arm 1 a front face 91, which, in conditions of assembly onto the bicycle, faces outwards, and a rear face 93, which, in conditions of assembly onto the bicycle, faces towards the frame of the bicycle are identified.

The elongated body 2 is made in a single piece of composite material, comprising structural fibers incorporated in a polymeric material. Typically, the structural fibers are selected from the group consisting of carbon fibers, glass fibers, aramid fibers, ceramic fibers, boron fibers and combinations thereof, carbon fibers being preferred. The polymeric material is typically a thermosetting material, preferably comprising an epoxy resin. However, the possibility of using a thermoplastic material is not excluded.

The structural fibers are suitably arranged inside the elongated body 2, so as to form different structures that react to different types of stresses.

In particular, the intermediate portion 15 comprises a non-structured inner portion which, in the illustrated preferred embodiment, is a cavity 20.

The outer reinforcement structure comprises a tubular structure 35, arranged around the cavity 20, that extends longitudinally less than the longitudinal intermediate portion 15 (illustrated in FIG. 1 by the two broken lines), but not more than equal to portion 15 so that the tubular structure 35 does not touch the coupling seats 38, 39.

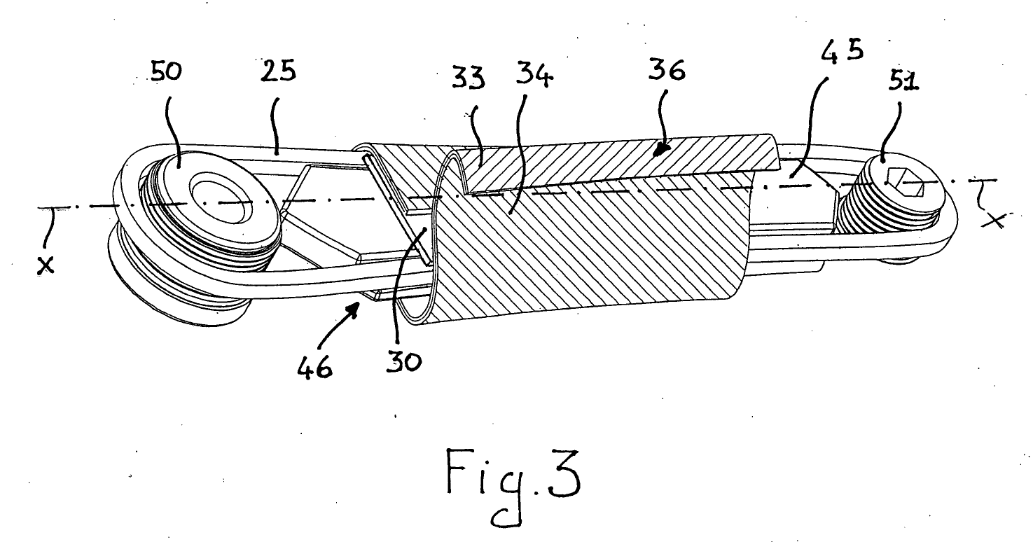

The tubular structure 35 functions to provide adequate resistance to bending and torsion stresses. The tubular structure 35 has at least one sheet 36 of composite material wound multiple times around the longitudinal axis X-X, as made clearer hereafter with reference to the method for manufacturing the crank arm 1. In the preferred embodiment illustrated here, the sheet 36 comprises two layers 33, 34 of unidirectional continuous structural fibers having a respective preferential direction of extension inclined with respect to the longitudinal axis X-X (FIG. 3). It has been observed that, to ensure optimal resistance to torsion and bending stresses, it is preferable that the preferential direction of extension of the structural fibers of one layer be inclined with respect to the preferential direction of extension of the structural fibers of the other layer by about 90° and that such preferential directions of extension be both inclined by about 45° with respect to the longitudinal axis X-X.

The elongated body 2 preferably also comprises an intermediate reinforcement structure. In the preferred embodiments described here, such an intermediate reinforcement structure has a bundle 25 of unidirectional continuous structural fibers that extend longitudinally throughout the elongated body 2, winding in a loop around the end portions 5, 10 and the intermediate portion 15 and enclosing the coupling seats 38, 39. The bundle 25 serves the function of resisting overall the traction loads, but a minimum contribution to resist other loads is also not excluded.

At the intermediate portion 15, the bundle 25 crosses the cavity 20 twice and is arranged between it and the tubular structure 35.

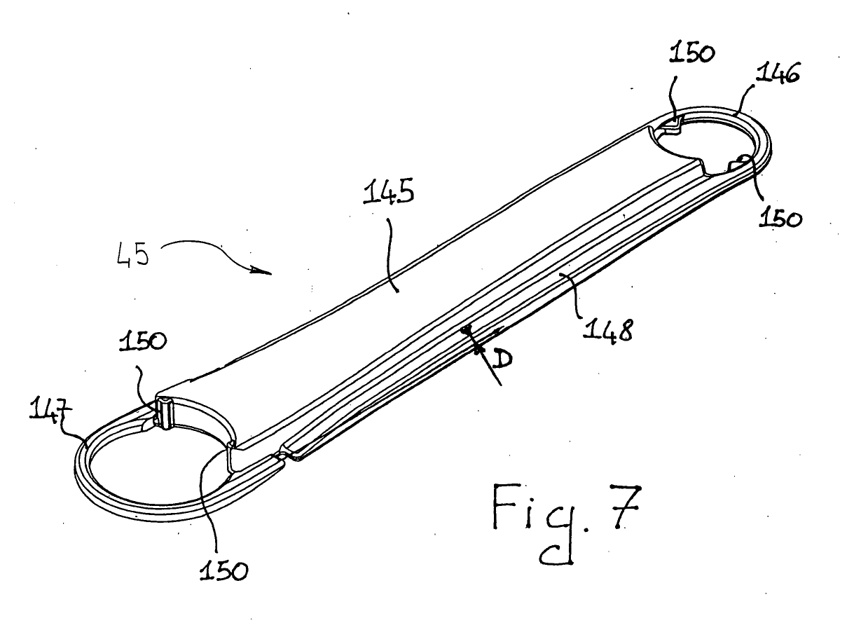

What has been described can be seen in detail in the cross section of the intermediate portion 15 shown in FIG. 6. Going from the inside towards the outside, the cavity 20 and the intermediate reinforcement structure, which in this cross section comprises two branches of the bundle 25 and is arranged, with respect to the cavity 20, closer to the front face 91 of the crank arm 1 are encountered first.

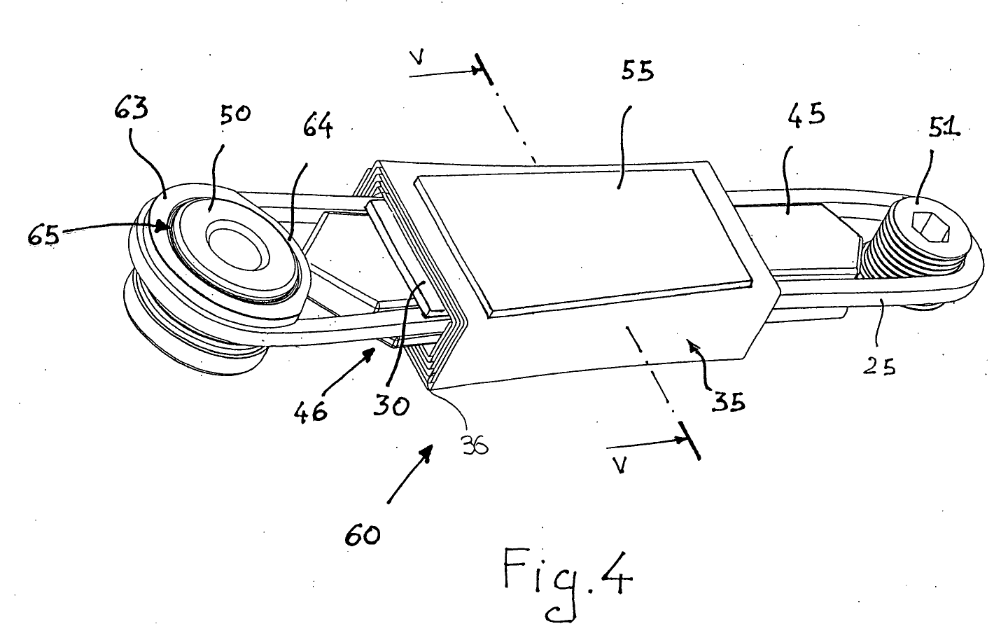

The two branches of the bundle 25 have a substantially rectangular section with a height preferably equal to about half the height of the cavity 20. In particular, the cavity 20 occupies a space defined by a first bottom area 20a having a certain surface extension and by a second top area 20b having a smaller surface extension (in FIG. 4 such areas are separated by a broken separation line) and the two branches of the bundle 25 occupy a space having a surface extension equal to the difference of the areas 20a, 20b.

In general, the section of the two branches of the bundle 25 can be varied; nevertheless, it is important that each portion of the surfaces 26 of each branch that faces the outer reinforcement structure, however as configured, is opposite a respective surface portion 27 facing the cavity 20, or rather, in general, facing the inner portion substantially without structural strength of the intermediate portion 15.

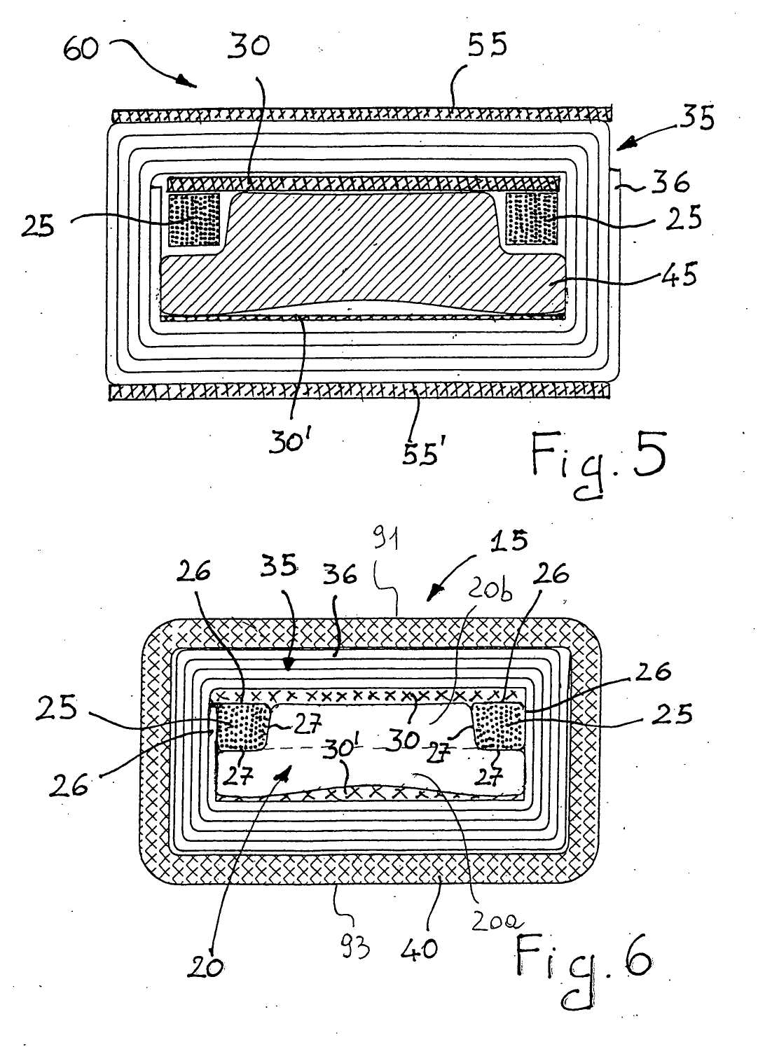

Preferably, the intermediate portion 15 has a substantially rectangular section and the start and end of the sheet 36 wound to form the tubular structure 35 are arranged at a central area of one of the sides of the section, unlike what is illustrated in FIG. 5 (which shows the start and end of the sheet 36 arranged on opposite sides of the section). The applicant has indeed found that the corners of the section are points of concentration of the tensions and has thought to position the start and the end of the sheet 36 far from these corners to avoid possible starts of fractures.

Going towards the outside layers 30 and 30′ of filling material at the interface between cavity 20 and tubular structure 35, preferably, a layer of filling material is also provided at the interface between cavity 20 and intermediate reinforcement structure 25 and between intermediate reinforcement structure and tubular structure 35, so that the bundle 25 is in contact with the filling material and not with the tubular structure. Furthest towards the outside there is finally a layer 40 of filling material, which ensures uniformity of the outer surface of the crank arm 1.

The aforementioned filling material is preferably a composite material comprising structural fibers with random distribution, for example in the form of pieces of fiber or small sheets of fabric, incorporated in polymeric material, as described in patent application US 2005/0012298 to the same applicant, incorporated herein for reference as if fully set forth. The filling material must in any case have the characteristic of flowing under pressure, so as to be able to reach all of the desired points of the crank arm 1 during its manufacture through molding, as shall be described in detail hereafter. The same filling material preferably also forms the end portions 5, 10.

As an alternative to what has been stated above, the bundle 25 can be arranged outside the tubular structure 35, or incorporated between its spirals.

In alternative embodiments it is also possible to foresee respective cavities not communicating with the cavity 20 at one or both of the end portions 5, 10.

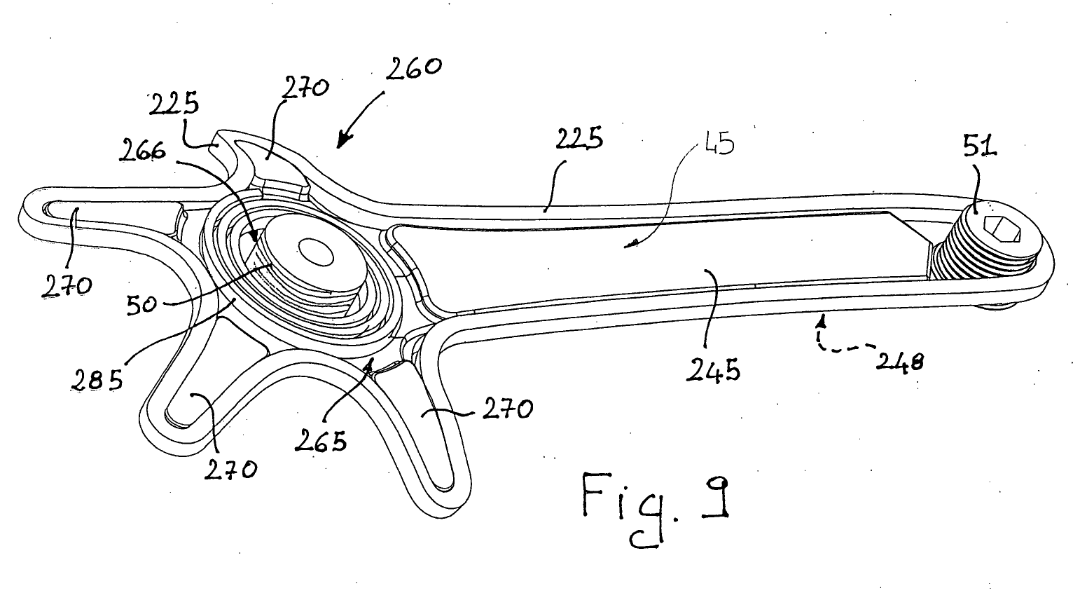

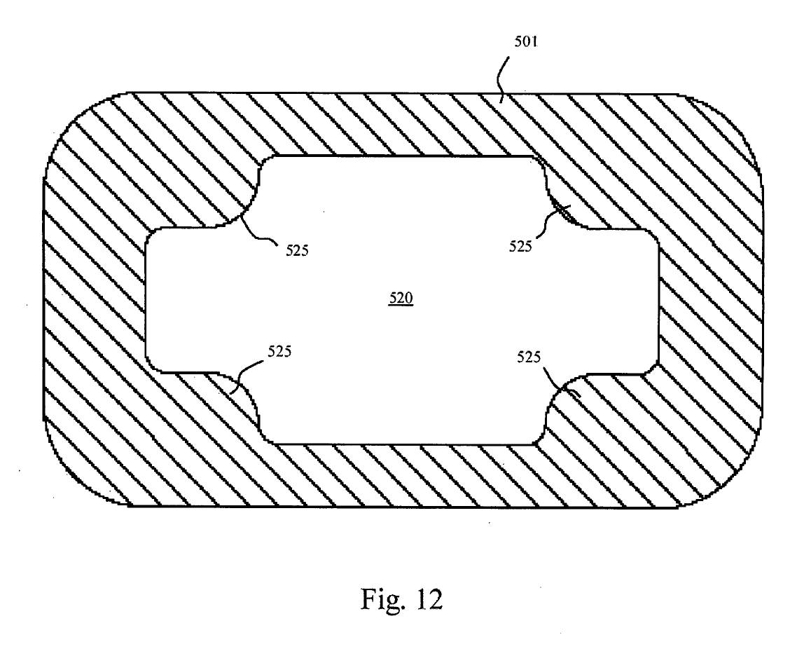

It should be noticed that the protrusions generated in the cavity 20 by the bundle 25, 225 are ribs that cross the cavity along its entire length. This has the effect of stiffening the crank arm while maintaining a clean design of its external surface. In order to achieve this result it is not necessary to have two ribs, as in FIG. 6, or in the crank arm obtained through the intermediate product of FIG. 9, but one rib is enough, even if more ribs are better. For example, FIG. 12 shows four ribs 525 protruding in the cavity 520 of the crank arm 501. In the case of a crank arm made of composite material as described above, the better solution is, of course, to realize the ribs through a bundle of unidirectional structural fibers, However, they could be made of other composite material. In addition, it should be noticed that the ribs inside the cavity are also useful for crank arms made of materials other than a composite material, such as an aluminum alloy or other kinds of light metals, in which case their stiffening effect is even higher.

FIGS. 4 and 5 show a preferred embodiment of an intermediate product 60 that can be used to manufacture the crank arm 1.

The intermediate product 60 comprises a core 45, the bundle 25 of unidirectional continuous structural fibers that extends longitudinally around the core 45, the tubular structure 35 with at least one sheet 36 of composite material wound axially many times (e.g., 4-5 times) around the core 45 and the bundle 25, the two layers of filling material 30, 30′ (only one of which can be seen in FIG. 4) arranged between each face of the core 45 and the tubular structure 35 and two layers of filling material 55 and 55′ applied to the outside of the tubular structure 35, as shown in FIG. 5. Two forming elements 50 and 51 of the opposite ends of the crank arm are arranged on longitudinally opposite sides of the core 45 in such a way that the bundle 25 winds in a loop around the forming elements 50, 51 and the core 45.

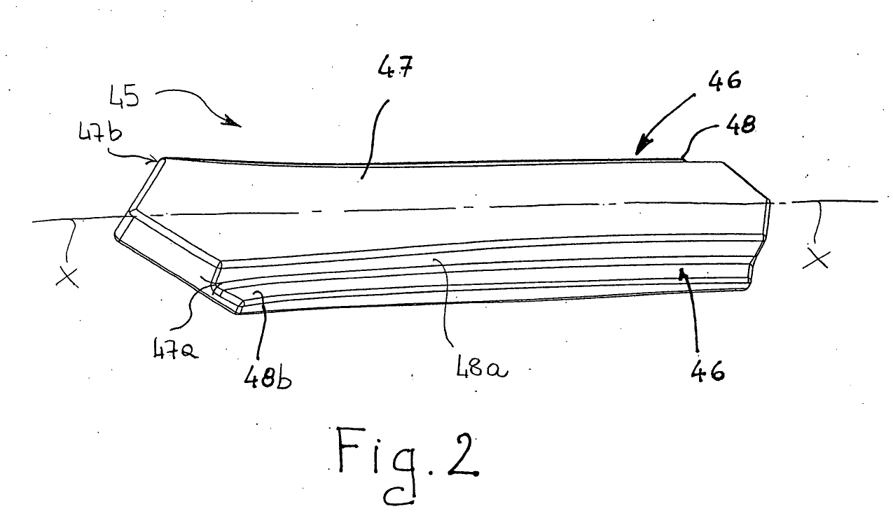

The core 45 (FIG. 2) has an elongated body 47 arranged to define the longitudinal axis X-X in the finished crank arm 1. The elongated body 47, at two opposite longitudinal sides 47a, 47b, comprises respective housing seats 46 adapted to receive the two branches of the bundle 25. The housing seats 46 are defined by a vertical side surface 48a of the elongated body 47 and by a horizontal projecting surface 48b that projects laterally from such a side surface 48a. The horizontal projecting surface 48b preferably has a vertical dimension equal to about half the height of the elongated body 47.

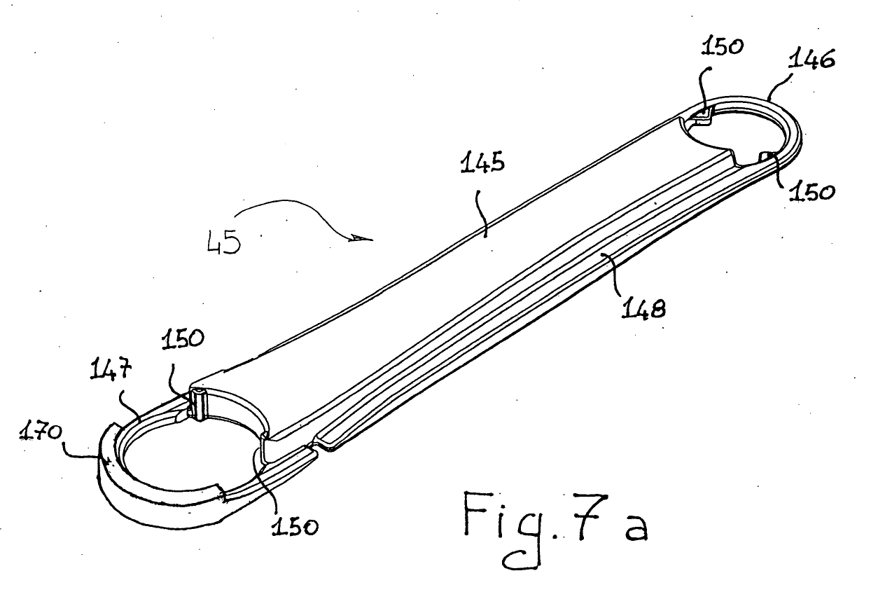

FIGS. 7 and 7a illustrate alternative embodiments of the core 45, particularly suitable for manufacturing a crank arm 1 in which the cavity 20 also extends to the end portions 5, 10. In these embodiments, the core 45 comprises a central elongated body 145 and two rings 146 and 147 connected thereto at the opposite longitudinal ends thereof. Such rings are adapted to surround the forming elements 50, 51 and thus to form cavities around the coupling seats 38, 39 in the finished crank arm.

The elongated body 145, like the elongated body 47 in the embodiment described above, comprises, at the two opposite longitudinal sides thereof, respective projecting surfaces 148 that project laterally.

The rings 146, 147 preferably have at least in part a height shorter than the height of the central body 145, so as not to compress the bundle 25 wound around the forming elements 50, 51 during the molding operations.

The height of the rings 146, 147 can be the same as the height of the projecting surfaces 148 or different. In the embodiment of FIG. 7, in particular, the ring 146, adapted to form a cavity around the seat 39 for coupling with the pedal lies on the same longitudinal plane as the projecting surface 148, whereas the ring 147 adapted to form a cavity around the seat 38 for coupling with the bottom bracket assembly, lies on a plane parallel to that of the projecting surface 148, but offset by a distance D.

FIG. 7a, on the other hand, shows an embodiment in which the ring 147 has a portion 170 of different thickness, and in particular greater thickness, with respect to that of the remaining portion of the ring 147. A similar configuration could also be present in the ring 146.

One or both of the rings 146, 147 can comprise positioning elements, which, pressing against the forming elements 50, 51 in the molding step, prevent the core 45 from moving. In the embodiments illustrated here the positioning elements consist of a pair of nodes 150 extending radially towards the inside of the ring 146, 147.

Irrespective of the embodiment of the core 45, to allow the removal by melting of the crank arm 1 when this has been formed, the core 1 is made from a metal alloy having a low melting point (eutectic), preferably tin, antimony, and lead. The alloy has a composition such as to have a melting point slightly higher Tf than the cross-linking temperature Tc of the polymeric material in the various composite materials used to make the body of the crank arm 1. In particular it is preferable to respect the following relationship:
Tf=Tc+ΔT
where Tf is between about 65° C. and about 185° C. and in any case is not more than about 200° C. so as not to damage the composite material; Tc is between about 60° C. and about 180° C.; ΔT is preferably between about 1° C. and about 25° C., about 5° C. being the preferred value.

The forming elements 50, 51 can either be profile-creating inserts, which, when the crank arm is formed, are removed and replaced with respective coupling inserts 78 and 80, respectively, for coupling with the bottom bracket assembly and with the pedal, or else they can consist of the coupling inserts 78, 80 themselves. In this last case the coupling inserts 78, 80 are co-molded with the crank arm as described in European patent application no. 05425576.5 to the same Applicant, incorporated herein by reference as if fully set forth.

One or both of the forming elements 50, 51 are associated with a holding element 63, so that, during the molding of the crank arm, it acts on the bundle 25 on the opposite side with respect to the projecting surface 48b (or 148) of the core 45. As holding element 63 it is possible for example to use a ring nut or a washer screwed onto an external threading 65 formed on the forming elements 50, 51, but the possibility of any other type of coupling is not excluded. In the embodiment of FIG. 4 the holding element 63 has an outer surface portion 64 of lesser thickness, which is intended to face towards the core 45. The advantage of such a configuration is that the core 45 can be moved more towards the insert 50.

In the case of a left crank arm, like the one illustrated in FIG. 1, the area of maximum stress of the crank arm is the area for coupling with the bottom bracket assembly, on the side facing towards the frame. For this reason the holding element 63 holds the bundle 25 in this area, whereas in the intermediate portion 15 the bundle 25 is located on the opposite side due to the thrust of the projecting surface 48b (or 148) of the core. In practice, in a left crank arm manufactured in accordance with the present invention, the bundle 25, going from the intermediate portion 15 of the crank arm to the end portion 5 for coupling with the bottom bracket assembly of the bicycle, has a substantially S-shaped arrangement.

Since, preferably, the holding element 63 remains trapped in the finished crank arm, it is desirable for it to be of low weight, therefore it is preferably made from a composite material, of a type selected from those described for manufacturing the rest of the crank arm, or from a metal alloy, like an aluminum alloy. It has been found that a ring nut made from phenolic resin loaded with 40-50% glass fiber gives excellent performance results combined with a particularly low cost.

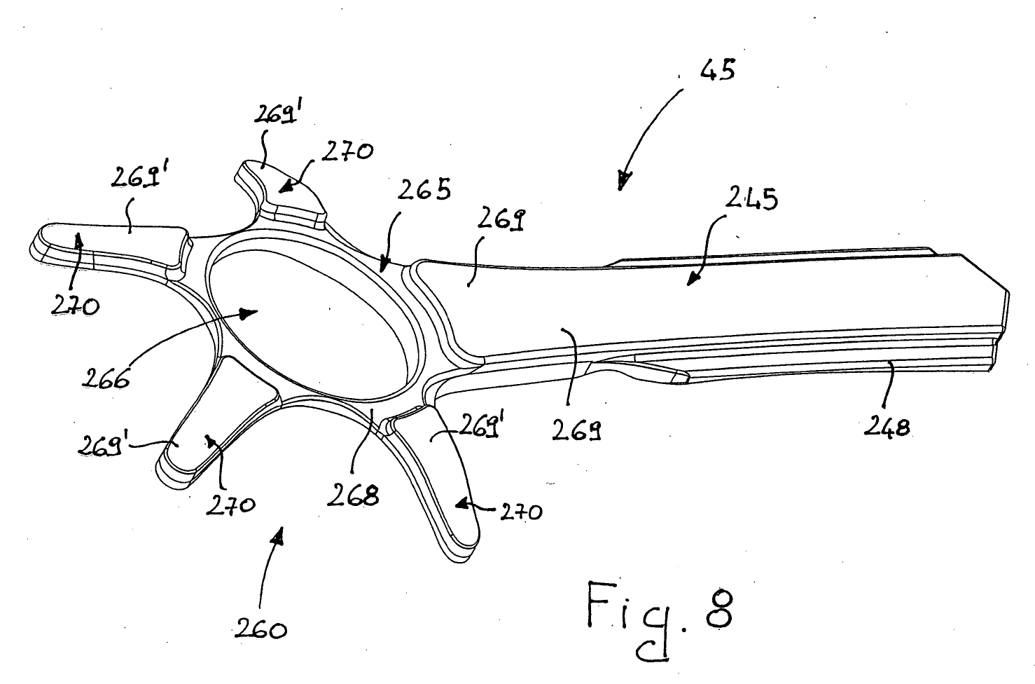

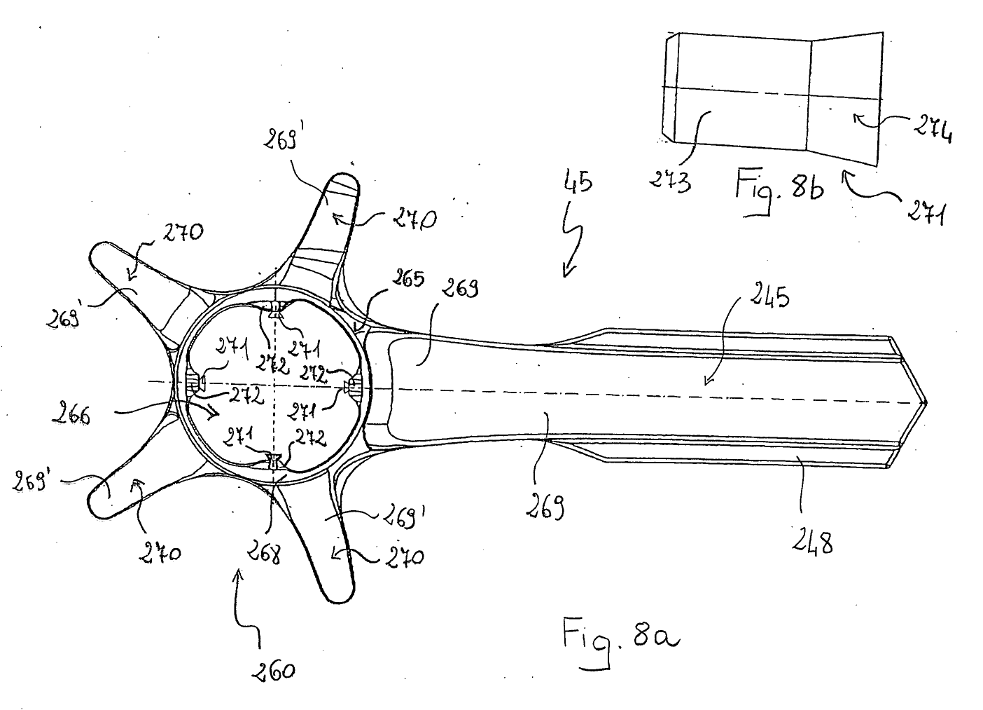

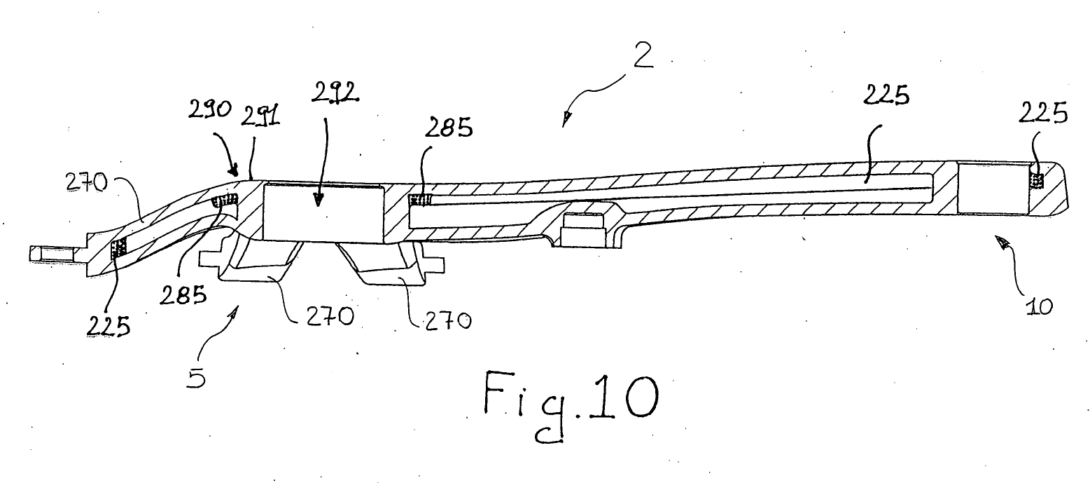

FIG. 8 illustrates a further embodiment of the core 45, particularly suitable for manufacturing a right crank arm, indicated with reference numeral 2 in FIG. 10, which has support spokes 270 of the gear wheels at the first end portion 5.

In this embodiment the core 45 comprises an elongated body 245 having an end defining a star 260 with four spokes 270, adapted to form respective cavities in the support spokes of the finished crank arm.

The elongated body 245 has projecting surfaces 248 that project laterally from the two opposite longitudinal sides thereof. However, differently from what has been described for the embodiments of the core 45 adapted to the manufacture of the left crank arm 1, the projecting surfaces 248 do not extend for the entire length of the elongated body 245, but rather they are interrupted before they join with the star-shaped portion 260. This promotes the thickening of the body made from composite material of the finished crank arm at such a join, where there is notoriously a concentration of tensions.

The spokes 270 project radially around a hole 266 having a diameter such as to allow the passage of the forming element 50 (FIG. 9). The periphery 265 of the hole 266 has a height shorter than the height of the spokes 270 and of the elongated body 245. In particular, the front face 268 of the periphery 265 of the hole 266 lies on a plane that is offset with respect to the front faces 269 and 269′ of the elongated body 245 and of the spokes 270 respectively, so as to form a recess 265. The recess 265 has the purpose of making, at a front face 291 in the finished crank arm 2, a thickened area 290 around a seat 292 for the insertion of the coupling insert 78 with the bottom bracket assembly. The spokes of the finished crank arm shall thus have respective cavities having a height greater than that of the cavity about the seat 292.

FIG. 8a shows a preferred embodiment of the core 45 of FIG. 8. Such a core differs from the one illustrated in FIG. 8 for the sole reason that it comprises four centering elements 271 associated with the periphery 265 of the central hole 266 and extending radially towards the inside of the central hole 266. In particular, the centering elements 271 are associated with the periphery 265 of the central hole 266 at respective thickened areas 272 of such a periphery extending radially towards the inside of the central hole 266.

Such centering elements 271, advantageously, are made from a composite material, of a type selected from those described for manufacturing the rest of the crank arm. For example, they can be made from phenolic resin loaded with 40-50% glass fiber, or a metal alloy, like an aluminum alloy. The centering elements 271 are to be lost, in the sense that they shall constitute part of the finished crank arm. Their function is that of keeping the forming element in centered position inside the central hole 266 during the molding of the crank arm, at the same time avoiding the core from being able to go into abutment against such a forming element (a similar function is carried out by the holding element 63 in a right crank arm). Typically, indeed, the forming insert of the end portion of the crank arm has an outer threading for making a corresponding internal threading in the hole of the coupling seat made in the end portion of the crank arm adapted to couple with the bottom bracket assembly of the bicycle. A possible abutment of the core against such a threading would indeed lead to the generation of areas of discontinuity in the thread formed on the finished crank arm. On the other hand, the fact that the centering elements 271 are made from the same material as the crank arm ensures that, during molding, they behave like the rest of the material that shall constitute the finished crank arm, contributing to the generation of a continuous and uniform profile in the seat for coupling with the bottom bracket assembly of the bicycle.

As better illustrated in FIG. 8b, each centering element 271 comprises a substantially cylindrical body portion 273 and a substantially frusto-conical body portion 274. The centering element 271 is coupled with the respective thickened area 272 of the periphery 265 of the central hole 266 through the respective cylindrical body portion 273, so that its frusto-conical body portion 274 extends cantilevered inside the central hole 266. Advantageously, the coupling with the periphery 265 through the frusto-conical body portion 274 prevents a possible slipping of the centering elements 271 from the respective seats 272 due to micro-breaks or micro-fractures at such a coupling area; such slipping would lead to the presence of solid bodies free to move inside the crank arm, with the consequent generation of noise during pedaling.

In the embodiment illustrated in FIG. 8a four centering elements 271 arranged at 90° from each other are used. In alternative embodiments, three centering elements are used arranged at 120° apart, or two centering elements arranged symmetrically with respect to the longitudinal axis X-X and positioned in the semi-circle closest to the elongated body 245 of the core 45.

FIG. 9 shows in particular how bundles of unidirectional continuous structural fibers, adapted to define an intermediate reinforcement structure in the finished crank arm, are preferably associated with the core 45 to form an intermediate product for manufacturing the right crank arm 2. In particular, a first bundle 225 is wound around the forming element 51 and around the elongated body 245 so as to be supported by the projecting surfaces 248 and so as to follow the profile of the spokes 270; a second bundle 285 is housed in the recess 265 wound in a spiral around the hole 266. Alternatively, the spiral can be formed from a portion of the bundle 225.

In the case of the right crank arm, the holding element 63 associated with the forming element 50 is superfluous and can be omitted. Indeed, it has been noted that, due to the star-shaped configuration, during molding the filling material flows radially around the forming element 50 and therefore does not generate the shriveling of the bundles 225 and 285, which can however typically occur during molding of the left crank arm 1.

The absence of holding elements at the end portions of the right crank arm ensures that, due to the thrusting of the projecting surface 148, 248 of the core 45 during the molding of the crank arm, the bundle 25 is arranged along the entire elongated body of the crank arm on the side facing outwards, right at the area of maximum stress of the right crank arm, which is indeed located at the area for coupling with the bottom bracket assembly, on the side facing outwards. Advantageously, also the bundle 285 wound in a spiral illustrated in FIG. 10 is arranged on this side.

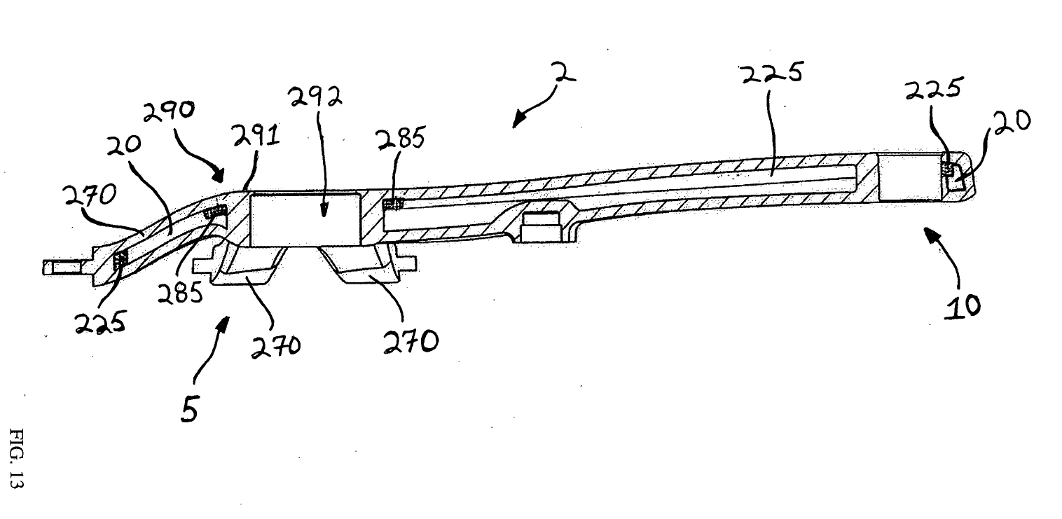

In an alternative preferred embodiment illustrated in FIG. 13, the cavity 20 also extends at one or both of the end portions 5, 10, embracing the coupling seats 38, 39. The height of the cavity 20 at the end portions 5, 10 can be equal to or less than its height at the intermediate portion 15. The difference in height can also involve just a sector of the end portions 5, 10. In the case in which the height is less, at the end portions 5, 10 the cavity 20 is defined closer to the rear face 93 of the crank arm 1.

With particular reference to FIGS. 3,4, and 10, a preferred embodiment of a method for manufacturing a crank arm in accordance with the present invention shall now be described. The steps of the method shall be illustrated with particular reference to the left crank arm 1, but what is described can also be applied without substantial modifications to the manufacture of the right crank arm 200.

In a first step of the method a core 45 is provided having a shape corresponding to the cavity 20 that is intended to be obtained in the finished crank arm.

Then the two forming elements 50,51 adapted to form the coupling seats 38, 39 at the end portions 5, 10 of the finished crank arm are provided.

Then the intermediate product 60 is formed (FIGS. 3 and 4).

The bundle 25 of unidirectional continuous structural fibers is wound in a loop around the core 45, in the housing seats 46, and around the forming elements 50, 51, arranged at the opposite longitudinal ends of the core 45. The layers of filling material 30, 30′ are rested on the core 45 on which the sheet 36 is wound so that the preferential directions of extension of the unidirectional continuous structural fibers of the layers 33, 34 form an angle of about 45° with respect to the longitudinal axis X-X of the core 45 (FIG. 3). The layers of filling material 55, 55′ are then applied outside the wound sheet 36.

The man skilled in the art will note that the layers of filling material 30, 30′, 55, 55′ can have whatever arrangement, their purpose being to flow when subjected to pressure towards the areas of a mold 70 at which the end portions 5 and 10 of the crank arm 1 will be formed. Amongst the various possibilities it is also possible to provide the necessary filling material, instead of in layers, in masses positioned in the aforementioned areas.

In a subsequent step of the method, the intermediate product 60 thus obtained is preheated bringing it to a predetermined preheating temperature for a predetermined preheating time which are sufficient to make the polymeric material of the composite material capable of flowing under pressure. Preferably, the intermediate product 60 is kept at a preheating temperature of between about 80° C. and about 100° C. for a sufficient time to heat it homogeneously. More preferably it is kept at a value of between about 85° C. and about 90° C. for a time of between about 35 and about 55 min, so that the core has the time to reach such a temperature before the most outer layer of composite material ages excessively.

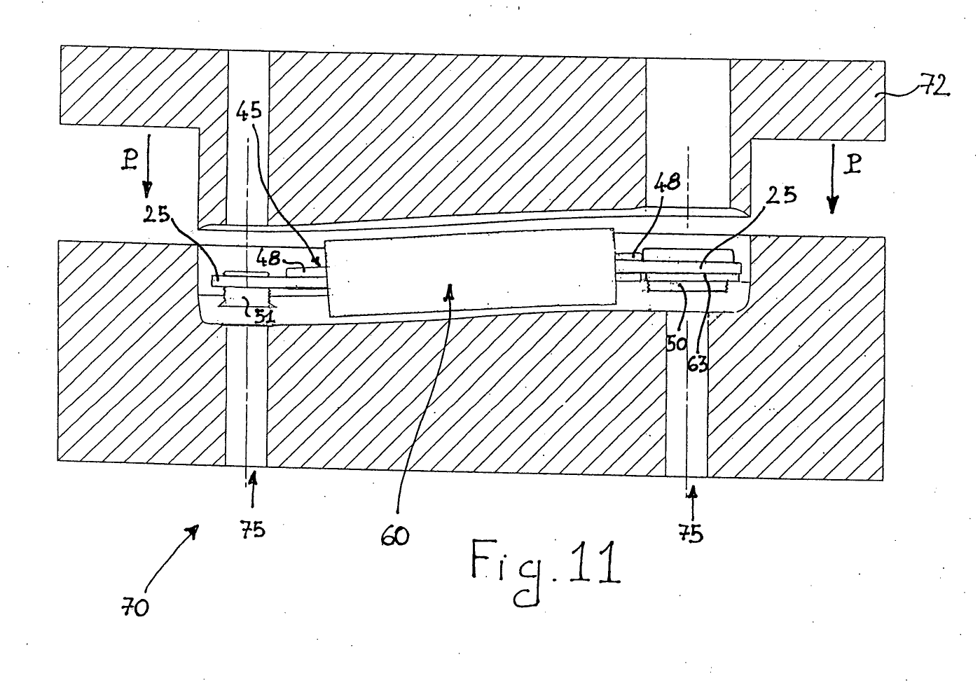

When the intermediate product 60 is sufficiently hot it is inserted into the cavity of a mold 70 (FIG. 11) having the shape of the crank arm 1 that it is wished to obtain and comprising a pressure element 72 with a predetermined thrusting direction P. In particular, the intermediate product 60 is inserted in such a way that the bundle 25 is closer to the front face 91 of the finished crank arm than to the rear face 93, and in such a way that the projecting surfaces 48 of the core 45 are arranged between the bundle 25 and the pressure element 72 along the thrusting direction P. The holding elements 63, if present, are arranged in such a way as to hold the bundle 25 counteracting the thrust in the direction P. The two forming elements 50, 51 are preferably fixed to the bottom of the mold 70 through screws applied through holes 75.

As an alternative to what has been described, the intermediate element 60 can be preheated directly inside the mold 70.

In a subsequent step of the method a pressure of between about 5 and about 350 bar is applied through the pressure element 72. Preferably, the pressure applied is selected in the upper area of the aforementioned range, to promote compacting of the material and degasification. In particular, the preferred pressure value is between about 5 bar and about 400 bar, more preferably between about 40 and about 300 bar and even more preferably between about 200 and about 300 bar. The pressure exerted makes the filling material flow until it fills the areas corresponding to the end portions 5, 10 of the crank arm 1. During the flowing of the filling material, the bundle 25 is kept under tension by the pressure exerted by the projecting surfaces 48 of the core 45, counteracted by the holding elements 63, in this way preventing shriveling.

When the molding step has ended the mold 70 is brought to a temperature corresponding to the cross-linking temperature Tc of the polymeric material present in the composite material forming the crank arm 1 for a sufficient time.

In a subsequent step of the method the finished crank arm 1 is removed from the mold 70.

After a subsequent cooling step, one or more holes 61 are formed in the crank arm 1, preferably on the rear face 93 intended to face towards the frame of the bicycle, and taking care not to cross the bundle 25. The hole 61 is illustrated with a broken line in FIG. 1 precisely to highlight that it is on the rear face 93 and not on the front face 91. Then the crank arm is heated up to the melting point Tf of the core 45, which therefore melts and flows out from the hole 61, leaving the cavity 20 free.

Optionally, a washing of the cavity 20 with oil at a predetermined temperature is carried out to remove the melting residues, possibly left stuck to the inner walls, and to avoid them generating undesired noises by detaching during use of the crank arm. The hole 61 is then closed preferably by applying a cap of phenolic resin.

What is claimed is:

1. Bicycle crank arm having an elongated body extending along a longitudinal axis X-X, said bicycle crank arm comprising:
a first end portion comprising a first seat for coupling with a bicycle bottom bracket assembly;
a second end portion comprising a second seat for coupling with a pedal; and
an intermediate portion extending between said first end portion and said second end portion and comprising an inner portion without structural strength, a first reinforcement structure and a second reinforcement structure arranged between said inner portion and said first reinforcement structure and comprising at least one bundle of structural fibers having at least in part a first orientation,
wherein said intermediate portion has a section perpendicular to said longitudinal axis X-X in which said inner portion occupies a space defined by a first area having a first surface extension and by a second area having a second surface extension and in which said second reinforcement structure occupies a space having a surface extension equal to the difference between said first and second areas.

2. Crank arm according to claim 1, wherein said second reinforcement structure is arranged in said perpendicular section so that each surface portion of said second reinforcement structure that faces said first reinforcement structure is opposite a respective surface portion of said second reinforcement structure that faces said inner portion.

3. Crank arm according to claim 1, wherein the fibers of said second reinforcement structure are unidirectional continuous structural fibers extending, at said intermediate portion, substantially parallel to said longitudinal axis X-X.

4. Crank arm according to claim 1, wherein the fibers of said first reinforcement structure are unidirectional continuous structural fibers extending substantially along at least one direction inclined with respect to said longitudinal axis X-X by a first predetermined angle.

5. Crank arm according to claim 4, wherein said first predetermined angle is equal to about 45°.

6. Crank arm according to claim 1, wherein the fibers of said first reinforcement structure are structural fibers having a random arrangement.

7. Crank arm according to claim 6, wherein said structural fibers comprise pieces of fibers or small sheets of fabric.

8. Crank arm according to claim 1, wherein said structural fibers are embedded in composite material.

9. Crank arm according to claim 1, wherein said elongated body has a first face adapted to face a bicycle frame and a second face opposite said first face and wherein said second reinforcement structure is closer to said second face than to said first face.

10. Crank arm according to claim 9, wherein said second reinforcement structure also extends at at least one of said end portions and wherein, at said at least one of said end portions, said second reinforcement structure is closer to said first face than to said second face.

11. Crank arm according to claim 9, further comprising at least one reinforcement structure also at at least one of said end portions and wherein, at said at least one of said end portions, said reinforcement structure is closer to said second face than to said first face.

12. Crank arm according to claim 11, wherein said reinforcement structure is an extension of said second reinforcement structure.

13. Crank arm according to claim 11, wherein said reinforcement structure is distinct from said second reinforcement structure.

14. Crank arm according to claim 1, wherein said intermediate portion of said elongated body has a section perpendicular to said longitudinal axis X-X wherein said second reinforcement structure has a height equal to about half the height of said inner portion.

15. Crank arm according to claim 1, wherein said inner portion is defined by a first cavity.

16. Crank arm according to claim 1, wherein said first and second end portions comprise a composite material comprising structural fibers arranged randomly and incorporated in a polymeric material.

17. Crank arm according to claim 1, wherein said structural fibers are selected from the group consisting of: carbon fibers, glass fibers, aramidic fibers, boron fibers, ceramic fibers and combinations thereof.

18. Crank arm according to claim 8, wherein said composite material is a thermosetting polymeric material.

19. Crank arm according to claim 1, wherein said second reinforcement structure extends longitudinally along said elongated body and winds in a loop around said first and second end portions and said intermediate portion.

20. Crank arm according to claim 19, wherein said elongated body further comprises, at at least one of said end portions, at least one holding element of a portion of said second reinforcement structure.

21. Crank arm according to claim 20, wherein said at least one holding element has a low thickness at an outer surface portion thereof facing said inner portion of said intermediate portion of said elongated body.

22. Crank arm according to claim 20, wherein said at least one holding element comprises a ring nut.

23. Crank arm according to any one of claims 20, wherein said at least one holding element is made from a composite material or a metal alloy.

24. Crank arm according to claim 23, wherein said at least one holding element is made from phenolic resin loaded with glass fiber.

25. Crank arm according to claim 24, wherein the content of said glass fibers in said phenolic resin is equal to 40-50%.

26. Crank arm according to claim 1, wherein at least one of said first and second end portions comprises, at said respective seat, a respective coupling hole.

27. Crank arm according to claim 26, further comprising, at said coupling hole, a plurality of centering elements of a forming element of said end portion.

28. Crank arm according to claim 27, wherein said centering elements are made from the same material as said crank arm.

29. Crank arm according to claim 27, wherein said centering elements extend cantilevered from said coupling seat inside said coupling hole.

30. Crank arm according to claim 26, further comprising a second cavity extending around said coupling hole.

31. Crank arm according to claim 26, comprising an insert inserted into said coupling hole.

32. Crank arm according to claim 1, wherein said crank arm is a right crank arm and comprises, at said first end portion, a plurality of spokes.

33. Crank arm according to claim 32, wherein said spokes have respective cavities that branch from said second cavity formed around said insert.

34. Crank arm according to claim 33, wherein said bundle of structural fibers extends along said spokes around the respective cavities.

35. Intermediate product for manufacturing a bicycle crank arm, said intermediate product comprising:
a core having an elongated body extending along a longitudinal axis X-X; and
a first reinforcement structure and a second reinforcement structure comprising at least one bundle of structural fibers having at least in part a first orientation,
wherein said intermediate product comprises a section perpendicular to said longitudinal axis X-X in which said core occupies a space defined by a first area having a first surface extension and by a second area having a second surface extension and in which said second reinforcement structure occupies a space having a surface extension equal to the difference between said first and second areas.

36. Intermediate product according to claim 35, wherein said second reinforcement structure is arranged in said perpendicular section such that each surface portion of said second reinforcement structure that faces said first reinforcement structure is opposite a respective surface portion of said second reinforcement structure that faces said core.

37. Intermediate product according to claim 36, wherein the fibers of said second reinforcement structure are unidirectional continuous structural fibers extending substantially parallel to said longitudinal axis X-X.

38. Intermediate product according to claim 36, wherein the fibers of said first reinforcement structure are unidirectional continuous structural fibers extending substantially along at least one direction inclined with respect to said longitudinal axis X-X by a first predetermined angle.

39. Intermediate product according to claim 38, wherein said first predetermined angle is equal to about 45°.

40. Intermediate product according to any one of claim 36, wherein said elongated body of said core comprises opposite longitudinal sides provided with respective housing seats of respective portions of said second reinforcement structure.

41. Intermediate product according to claim 35, wherein said core is made from a metallic material having a low melting point in order to allow its removal by melting when the crank arm has been manufactured.

42. Core for manufacturing a hollow bicycle crank arm, said core comprising an elongated body extending along a longitudinal axis X-X, wherein said elongated body comprises, at opposite longitudinal sides thereof, a side surface and a projecting surface that projects laterally from said side surface.

43. Core according to claim 42, further comprising:
a central body portion; and
two rings integrally associated with said elongated body at opposite ends of said central body portion.

44. Core according to claim 43, wherein a ring of said pair of rings has a height at least in part shorter than the height of said central body portion.

45. Core according to claim 44, wherein at least part of said ring has a height shorter than the height of said projecting surface.

46. Core according to claim 45, wherein the other ring of said pair of rings has a height substantially equal to the height of said projecting surface.

47. Core according to claim 43, wherein at least one ring of said pair of rings has at least one portion of ring having a height greater than the remaining portion of ring.

48. Method for manufacturing a bicycle crank arm, comprising the steps of:
providing a core adapted to define an inner cavity of an intermediate portion of a crank arm, the core comprising an elongated body extending along a longitudinal axis X-X;
providing two forming elements of opposite end portions of the crank arm;
providing an intermediate product comprising the core, a first reinforcement structure and a second reinforcement structure arranged between the core and the first reinforcement structure and comprising at least one bundle of structural fibers having at least in part a first orientation, the intermediate product having a section perpendicular to the longitudinal axis X-X in which the core occupies a space defined by a first area having a first surface extension and by a second area having a second surface extension and in which the second reinforcement structure occupies a space having a surface extension equal to the difference between the first and second areas;
associating the forming elements with the intermediate product, the forming elements being arranged between the core and the second reinforcement structure at opposite free ends of the core;
introducing the intermediate product with the forming elements into a cavity of a mold together with at least one mass of filling material comprising a polymeric material and capable of flowing under pressure, the mold being equipped with a pressure element and the cavity having the shape of the crank arm;
applying a predetermined pressure to the pressure element to make the filling material flow into the cavity;
heating the mold to a temperature corresponding to the cross-linking temperature of the polymeric material; and
opening the mold and removing the formed crank arm.

49. Method according to claim 48, wherein the second reinforcement structure is housed in a pair of housing seats formed on opposite longitudinal sides of the core.

50. Method according to claim 49, wherein each housing seat is defined by a side surface of the core and by a projecting surface that projects laterally from the side surface and the intermediate product is inserted into the cavity of the mold so that the pressure element acts upon a first portion of the second reinforcement structure through the projecting surface.

51. Method according to claim 50, further comprising the step of providing a holding element of a second portion of the second reinforcement structure on at least one of the forming elements such that the holding element acts on the second reinforcement structure on the opposite side to the projecting surface of the core.

52. Method according to claim 48, wherein said step of providing an intermediate product comprises the step of winding at least one bundle of unidirectional continuous structural fibers in a loop around said two forming elements and said core.

53. Method according to claim 48, wherein the core consists of a metallic material having a low melting point, said method further comprising, after said step of heating the mold, the steps of:
forming at least one hole on a surface of the crank arm; and
heating the crank arm up to the melting point of the metallic material having a low melting point in order to allow it to flow out.

54. Method according to claim 48, wherein the first reinforcement structure comprises unidirectional continuous structural fibers that extend along a preferential direction of extension and said step of providing the intermediate product comprises the step of arranging the at least one layer of structural fibers so that the preferential direction of extension is inclined with respect to the longitudinal axis X-X by a predetermined angle.

55. Method according to claim 54, wherein said predetermined angle is equal to about 45°.

56. Method according to claim 48, comprising, before said step of inserting the intermediate product and the at least one mass of filling material into the cavity of the mold, or after said step of inserting the intermediate product and the at least one mass of filling material into the cavity of the mold, and before said step of applying a predetermined pressure, the step of preheating the intermediate product and the at least one mass of filling material bringing it to a predetermined preheating temperature for a predetermined preheating time.

57. Method according to claim 48, wherein said step of inserting the intermediate product and the at least one mass of filling material into the cavity of the mold comprises the step of providing at least one first layer of the filling material between the core and the first reinforcement structure.

58. Method according to claim 57, wherein said step of inserting the intermediate product and the at least one mass of filling material into the cavity of the mold comprises the step of providing at least one second layer of the filling material outside the first reinforcement structure.

59. Bicycle crank arm having an elongated body extending along a longitudinal axis X-X, said bicycle crank arm comprising:
a first end portion comprising a first seat for coupling with a bicycle bottom bracket assembly;
a second end portion comprising a second seat for coupling with a pedal; and
an intermediate portion extending between said first end portion and said second end portion,
wherein at least one of said first and second end portions comprises, at said seat, a coupling hole and a cavity extending around said coupling hole.

60. Crank arm according to claim 59, wherein said at least one of said first and second end portions is at least in part made with a cross-linkable composite material capable of flowing under pressure before cross-linking.

61. Crank arm according to claim 59, wherein said cavity continuously surrounds said coupling hole.

62. Crank arm according to claim 59, wherein said cavity extends in said intermediate portion.

63. Crank arm according to claim 62, wherein said cavity has, at said at least one of said first and second end portions, a height at least in part shorter than the height of said cavity at said intermediate portion.

64. Crank arm according to claim 59, wherein said first and second end portions both comprise a respective cavity extending around the respective coupling holes.

65. Crank arm according to claim 64, wherein said cavity has, at one of said first and second end portions, a height at least in part shorter than the height of said cavity at said intermediate portion and, at the other of said first and second end portions, a height equal to the height of said cavity at said intermediate portion.

66. Crank arm according to claim 65, wherein said cavity of shorter height is defined at said first end portion.

67. Crank arm according to claim 59, wherein said crank arm is a right crank arm and comprises, at said first end portion, a plurality of spokes.

68. Crank arm according to claim 67, further comprising an insert inserted into said coupling hole.

69. Crank arm according to claim 68, wherein said spokes have respective cavities that branch from said cavity formed around said insert.

70. Crank arm according to claim 69, wherein the height of said cavity at said spokes is higher than that of said cavity around said coupling hole.

71. Crank arm according to claim 59, further comprising a layer of continuous structural fibers wound in a spiral around said coupling hole.

72. Crank arm according to claim 71, wherein the layer of structural fibers extends along said spokes around the respective cavities.

73. Core for manufacturing a hollow bicycle crank arm, said core comprising an elongated body extending along a longitudinal axis X-X, wherein said elongated body comprises a central body portion and two rings integrally associated with said elongated body at opposite ends of said central body portion.

74. Core according to claim 73, wherein a ring of said pair of rings has a height at least in part shorter than the height of said central body portion.

75. Core according to claim 73, wherein at least one ring of said pair of rings has at least one portion of ring having a height greater than that of the remaining portion of ring.

76. Core according to claims 73, wherein said rings comprise respective positioning elements extending radially towards the inside of said rings.

77. Core according to claim 73, wherein one of said two rings comprises a central hole and a plurality of spokes that extend radially outwards from said central hole.

78. Core according to claim 77, wherein said spokes have a height greater than the height of said ring.

79. Core according to claim 73, wherein said elongated body comprises, at opposite longitudinal sides thereof, a side surface and a projecting surface that projects laterally from said side surface, wherein said projecting surface extends parallel to said axis X-X for a part having a length shorter than the length of said central body portion.

80. A bicycle crank arm having an elongated body extending along a longitudinal axis X-X, said bicycle crank arm comprising:
a first end portion comprising a first seat for coupling with a bicycle bottom bracket assembly;
a second end portion comprising a second seat for coupling with a pedal; and
an intermediate portion extending between said first end portion and said second end portion and comprising an inner portion without structural strength, a first reinforcement structure and a second reinforcement structure arranged between said inner portion and said first reinforcement structure and comprising at least one bundle of structural fibers having at least in part a first orientation, the fibers of said second reinforcement structure are unidirectional continuous structural fibers extending, at said intermediate portion, substantially parallel to said longitudinal axis X-X,
wherein said intermediate portion has a section perpendicular to said longitudinal axis X-X in which said inner portion occupies an area that differs from a convex area at least for a portion occupied by the second reinforcement structure.

81. The bicycle crank arm according to claim 80, wherein said inner portion is defined by a first cavity.

82. The bicycle crank arm according to claim 80, wherein said elongated body has a first face adapted to face a bicycle frame and a second face opposite said first face and wherein said second reinforcement structure is closer to said second face than to said first face.

83. The bicycle crank arm according to claim 80, wherein said first and second end portions comprise a composite material comprising structural fibers arranged randomly and incorporated in a polymeric material.

84. The bicycle crank arm according to claim 80, wherein said second reinforcement structure extends longitudinally along said elongated body and winds in a loop around said first and second end portions and said intermediate portion.

85. The bicycle crank arm according to claim 84, wherein said elongated body further comprises, at at least one of said end portions, at least one holding element of a portion of said second reinforcement structure.

86. A bicycle crank arm having an elongated body, said bicycle crank arm comprising:
a first end portion comprising a first seat for coupling with a bicycle bottom bracket assembly;
a second end portion comprising a second seat for coupling with a pedal; and
an intermediate portion extending between said first end portion and said second end portion,
wherein at least one of said first and second end portions comprises, at said seat, a coupling hole and a cavity extending around said coupling hole,
said at least one of said first and second end portions is at least in part made with a cross-linkable composite material capable of flowing under pressure before cross-linking, and
said cavity continuously surrounds said coupling hole and extends in said intermediate portion.

87. The bicycle crank arm according to claim 86, further comprising a layer of continuous structural fibers wound in a spiral around said coupling hole.

88. The bicycle crank arm according to claim 86, further comprising an insert inserted into said coupling hole, wherein said crank arm is a right crank arm and comprises, at said first end portion, a plurality of spokes, said spokes have respective cavities that branch from said cavity formed around said insert, and a bundle of structural fibers extends along said spokes around the respective cavities.

89. A bicycle crank arm having an elongated body extending along a longitudinal axis X-X, said bicycle crank arm comprising:
a first end portion comprising a first seat for coupling with a bicycle bottom bracket assembly;
a second end portion comprising a second seat for coupling with a pedal; and
an intermediate portion extending between said first end portion and said second end portion and comprising an inner portion, a first reinforcement structure arranged around said inner portion and a second reinforcement structure comprising at least one bundle of structural fibers having at least in part a first orientation.

90. The bicycle crank arm of claim 89 wherein the second reinforcement structure is arranged between said inner portion and said first reinforcement structure.

91. A bicycle crank arm having an elongated body extending along a longitudinal axis X-X, said bicycle crank arm comprising:
a first end portion comprising a first seat for coupling with a bicycle bottom bracket assembly;
a second end portion comprising a second seat for coupling with a pedal; and
an intermediate portion extending between said first end portion and said second end portion and comprising an inner portion without structural strength, a first reinforcement structure and a second reinforcement structure arranged between said inner portion and said first reinforcement structure and comprising at least one bundle of structural fibers having at least in part a first orientation,
wherein the fibers of said second reinforcement structure are unidirectional continuous structural fibers extending, at said intermediate portion, substantially parallel to said longitudinal axis X-X.

92. A bicycle crank arm having an elongated body, said bicycle crank arm comprising:
a first end portion comprising a first seat for coupling with a bicycle bottom bracket assembly;
a second end portion comprising a second seat for coupling with a pedal; and
an intermediate portion extending between said first end portion and said second end portion,
wherein at least one of said first and second end portions comprises, at said seat, a coupling hole and a cavity extending around said coupling hole.

93. A bicycle crank arm having an elongated body, said bicycle crank arm comprising:
a first end portion comprising a first seat for coupling with a bicycle bottom bracket assembly;
a second end portion comprising a second seat for coupling with a pedal; and
an intermediate portion extending between said first end portion and said second end portion,
wherein at least one of said first and second end portions comprises, at said seat, a coupling hole and a cavity extending around said coupling hole, and said cavity continuously surrounds said coupling hole.

94. A bicycle crank arm having an elongated body extending along a longitudinal axis X-X, said bicycle crank arm comprising:
a first end portion comprising a first seat for coupling with a bicycle bottom bracket assembly;
a second end portion comprising a second seat for coupling with a pedal; and
an intermediate portion extending between said first end portion and said second end portion and comprising an inner portion without structural strength,
wherein said intermediate portion has a section perpendicular to said longitudinal axis X-X in which said inner portion occupies a non convex area.

95. The bicycle crank arm according to claim 94, wherein the crank arm is made of composite material.
